(19) United States
(12) Patent Application Publication
(10) Pub. No.: US 2016/0305166 A1
(43) Pub. Date: Oct. 20, 2016

(54) FUEL PORT ASSEMBLY AND SYSTEM FOR DETERMINING THE STATUS OF A FUEL DOOR

(71) Applicant: GM GLOBAL TECHNOLOGY OPERATIONS LLC, Detroit, MI (US)

(72) Inventors: CHRISTOPHER J. GEORGI, ROCHESTER HILLS, MI (US); ROGER H. CULVER, ROCHESTER HILLS, MI (US); PAUL W. ALEXANDER, YPSILANTI, MI (US); DOREL M. SALA, TROY, MI (US)

(21) Appl. No.: 14/691,158

(22) Filed: Apr. 20, 2015

(51) Int. Cl. E05B 81/72; E05B 85/28; E05B 83/34; E05B 85/22

(52) U.S. Cl. CPC E05B 81/72; E05B 85/22; E05B 85/28; E05B 83/34

(57) ABSTRACT

Systems and assemblies for determining the status of a fuel door of a vehicle are provided. A latching mechanism having a sensing target and an axis is rotatable about the axis through an unlocked position and a locked position and is longitudinally movable about the axis between an open position and a closed position. A sensor module is configured to detect a sensed position of the sensing target. The sensed position of the sensing target determines a state of the latching mechanism and the status of the fuel door.

### TECHNICAL FIELD

The technical field generally relates to fuel port assemblies, and more particularly relates to systems for determining the status of a fuel door of a vehicle.

### BACKGROUND

Modern vehicles, such as automobiles, are often equipped with fuel doors to allow for fuel such as gasoline or diesel to be supplied to the vehicle's tank. In hybrid or electric vehicles, these fuel doors may provide access to charge ports that allow onboard batteries to be charged by an external power source. Some vehicles include locks to keep the fuel door closed as well as to prevent unauthorized access to the fuel port. Some vehicles may further include a sensor to detect a lock/unlock status of the fuel door. However, the fuel door may be left open by an operator after a fueling event.

Accordingly, it is desirable to provide systems and assemblies for determining the status of a fuel door of a vehicle. In addition, it is desirable to determine whether the fuel door is locked or unlocked and further whether the fuel door is open or closed. Other desirable features and characteristics of the present invention will become apparent from the subsequent detailed description and the appended claims, taken in conjunction with the accompanying drawings and the foregoing technical field and background.

### SUMMARY

In one embodiment, a system for determining a status of a fuel door is provided. The system includes a latching mechanism having a sensing target and an axis. The latching mechanism is rotatable about the axis through an unlocked position and a locked position and is longitudinally movable about the axis between an open position and a closed position. The system further includes a sensor module configured to detect a sensed position of the sensing target. The sensed position of the sensing target determines a state of the latching mechanism and the status of the fuel door.

In one embodiment a system for determining a status of a fuel door is provided. The system includes a latching mechanism having a sensing target and an axis. The latching mechanism is rotatable about the axis through an unlocked position and a locked position and longitudinally movable about the axis between an axially outermost open position, an axially inward latched position, and an axially innermost depressed position. The system also includes a sensor module configured to detect a sensed position of the sensing target. The sensed position of the sensing target determines a state of the latching mechanism and the status of the fuel door.

In one embodiment a fuel port assembly for a vehicle is provided. The assembly includes a fuel port housing mounted to the vehicle, a fuel door movably mounted with a hinge to the housing, and a system for determining a status of the fuel door. The system is mounted to the housing and includes a latching mechanism having a sensing target and an axis. The latching mechanism is rotatable about the axis through an unlocked position and a locked position and longitudinally movable about the axis between an axially outermost open position, an axially inward latched position, and an axially innermost depressed position. The system also includes a sensor module configured to detect a sensed position of the sensing target. The sensed position of the sensing target determines a state of the latching mechanism and the status of the fuel door.

### DESCRIPTION OF THE DRAWINGS

The exemplary embodiments will hereinafter be described in conjunction with the following drawing figures, wherein like numerals denote like elements, and wherein:

FIG. 1 illustrates a system for determining a status of a fuel door in accordance with an exemplary embodiment;

FIG. 2 illustrates a fuel port assembly including the system for determining the status of the fuel door in accordance with an exemplary embodiment;

FIGS. 3 A-D illustrate the latching of the latching mechanism in accordance with an exemplary embodiment;

FIGS. 4 A-B illustrate the locked state of the latching mechanism in accordance with an exemplary embodiment;

FIGS. 5 A-C illustrate the unlocking of the latching mechanism in accordance with an exemplary embodiment;

FIGS. 6 A-B illustrate an arrangement and operation of the sensor module and sensing target in accordance with an exemplary embodiment;

FIGS. 7 A-B illustrate an arrangement and operation of the sensor module and sensing target in accordance with an exemplary embodiment;

FIGS. 8 A-C illustrate an arrangement and operation of the unlocking mechanism in accordance with an exemplary embodiment; and

FIGS. 9 A-B illustrate an arrangement and operation of the unlocking mechanism in accordance with an exemplary embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Referring to the Figures, wherein like numerals indicate like parts throughout the several views, a vehicle 10 having a fuel port assembly 20 with a system 100 for determining a status of a fuel door 24 is shown herein. In the exemplary embodiments, the vehicle 10 is an automobile. However, the system 100 for determining a status of a fuel door 24 may be implemented and/or utilized in other types of vehicles or in non-vehicle applications. For instance, other vehicles include, but are not limited to, aircraft, spacecraft, buses, trains, etc.

The term fuel port assembly 20 as used herein relates to fuel ports for refueling vehicles 10 and is not limited to a specific type of vehicle fuel. For example, the fuel port assembly 20 may be used with vehicles 10 that operate on gasoline or diesel as well as electric or hybrid vehicles having charge ports for charging onboard batteries from an external power source. Additional fuels may be supplied to the vehicle 10 through the fuel port assembly 20 including, but not limited to, propane, compressed natural gas, ethanol, bio-diesel, etc.

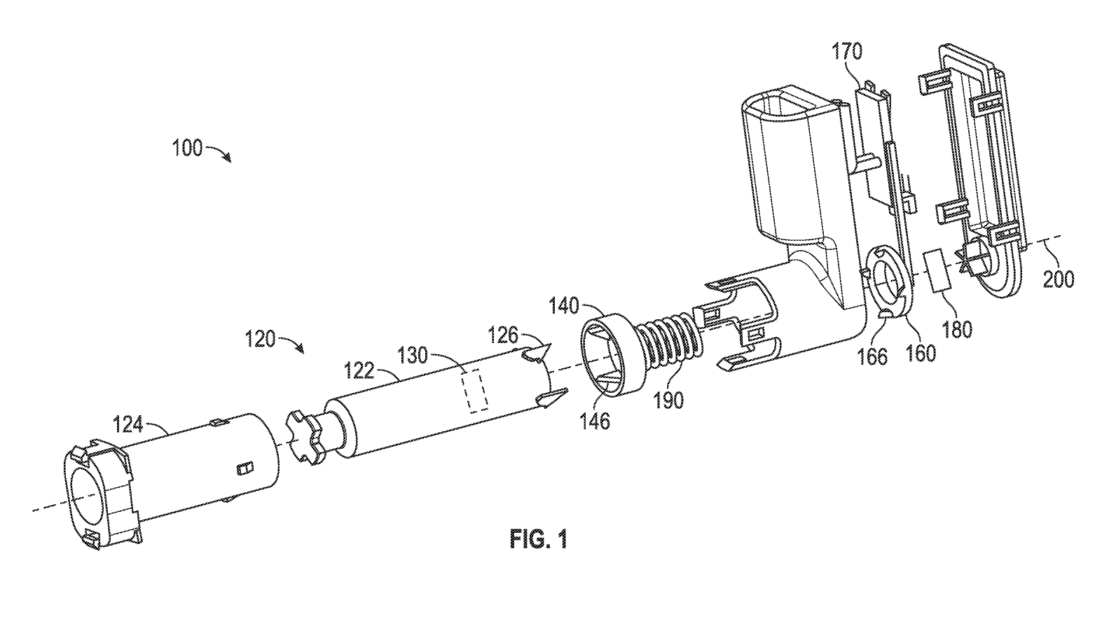

As shown in FIG. 1, the system 100 includes a latching mechanism 120, a locking mechanism 140, an unlocking mechanism 160, and a sensor module 180. The interaction between the components of the system 100 will be made more clear when the following is read with reference to the Figures.

With reference to FIG. 1, an embodiment of the system 100 is provided in an exploded view. The system 100 includes the latching mechanism 120 which includes the plunger 122 and the plunger housing 124. The plunger 122 is generally cylindrical in shape and has a plurality of angled latching teeth 126 about a lower circumference of the plunger 122. The plunger 122 moves longitudinally along and rotatably about the axis 200 and includes a sensing target 130. The latching mechanism 120 is rotatable about the axis 200 through an unlocked position and a locked position. The locking mechanism 120 is movable about the axis 200 between an open position and a closed position.

The sensing target 130 is housed within the latching mechanism 120 and sensed by the sensor module 180. In a non-limiting example, the sensing target 130 is a magnet and the sensor module 180 is a Hall-Effect sensor. A Hall-Effect sensor is a sensor that varies an output voltage in response to a magnetic field, such as a magnetic field generated by the sensing target 130. The sensor module 180 is configured to detect a sensed position of the sensing target 130. The sensed position may be used to determine the position and orientation of the sensing target 130 and, in turn, the state of the latching mechanism 120 and the status of the fuel door 24.

One skilled in the art will appreciate that alternative sensor module 180 and sensing target 130 combinations may be used to determine the state of latching mechanism 120 and the status of the fuel door 24. Non-limiting examples of sensor module 180 and sensing target 130 combinations include inductive position sensors, resonant position sensors, eddy current proximity sensors, etc.

The locking mechanism 140 is configured to rotate the latching mechanism 120 about the axis 200 from the unlocked position to the locked position as the latching mechanism 120 moves longitudinally along the axis 200 from the open position to the closed position. The locking mechanism 140 has a plurality of locking teeth 146 that are configured to engage the latching teeth 126 of the latching mechanism 120.

The unlocking mechanism 160 is configured to selectably permit the latching mechanism 120 to rotate from the locked position to the unlocked position. The unlocking mechanism 160 has a plurality of unlocking teeth 166 that are configured to engage the latching teeth 126 of the latching mechanism 120 and rotate the latching mechanism 120 to the unlocked position. The unlocking mechanism 160 is selectably rotatable about the axis 200 by an actuator 170. The actuator 170 is controlled by a vehicle control system (not shown) such as door locks, general vehicle control unit, etc.

A biasing mechanism 190 is configured to axially bias the latching mechanism 120 towards the open position. In a non-limiting embodiment, the biasing mechanism 190 is a spring. Stated generally, the biasing mechanism 190 resists the longitudinal motion of the latching mechanism 120 from the open position along the axis 200 to the closed position. One skilled in the art will appreciate that the biasing mechanism 190 may be located in different locations of the system 100 to bias the latching mechanism 120. For example, the biasing mechanism 190 may be placed within the plunger housing 124 or on a top side of the plunger 122.

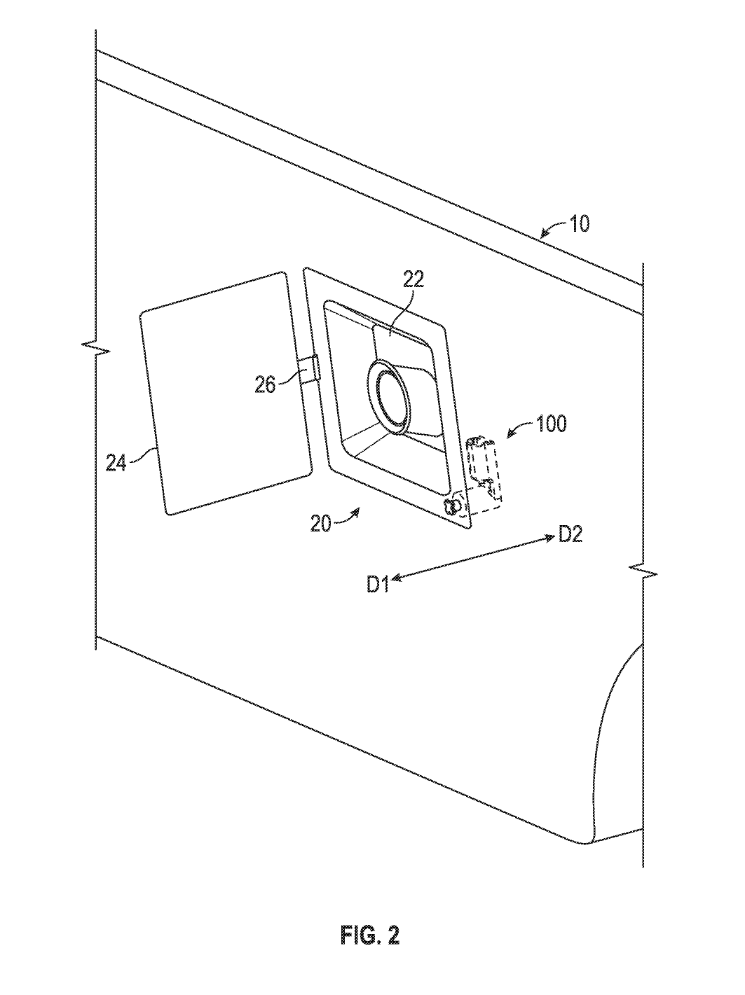

With reference to FIG. 2, a vehicle 10 having a fuel port assembly 20 with the system 100 for determining a status of a fuel door 24 is provided. The assembly 20 includes a fuel port housing 22 mounted to the vehicle 10 and a fuel door 24 mounted to the housing 22 with a hinge 26. As detailed above, the fuel door 24 provides access from the exterior of vehicle 10 to the interior of the housing 22 to supply the vehicle 10 with fuel and/or electric power. The system 100 is used to determine the status of the fuel door 24 and communicate that information to various vehicle systems (not shown). For example, a vehicle system may alert an operator when the fuel door 24 is left in the open position or ensure that the fuel door 24 is locked in the closed position.

The fuel door 24 may contact the latching mechanism 120 of the system 100 when the fuel door 24 is not fully closed, for example, when the fuel door 24 is slightly ajar. The point in the rotation of the fuel door 24 when the fuel door 24 first makes contact with the system 100 is defined as the open position. The point in the rotation of the fuel door 24 when the fuel door 24 is fully closed and flush with the exterior of the vehicle 10 is defined as the closed position. In an embodiment, the fuel door 24 is released from the closed position by depressing the fuel door 24 in a vehicle inward direction D2.

As the fuel door 24 is moved from the open position to the closed position, the latching mechanism 120 is depressed longitudinally in a vehicle inward direction D2 along the axis 200. In an embodiment, the fuel door 24 is depressed in a vehicle inward direction D2 slightly past the exterior surface of the vehicle 10 and then returns in a vehicle outward direction D1 to be flush with the exterior surface in the closed position. Similarly, when the fuel door 24 is moved from the closed position to the open position, the latching mechanism 120 is initially depressed in a vehicle inward direction D2 before being released in a vehicle outward direction D1 to the open position.

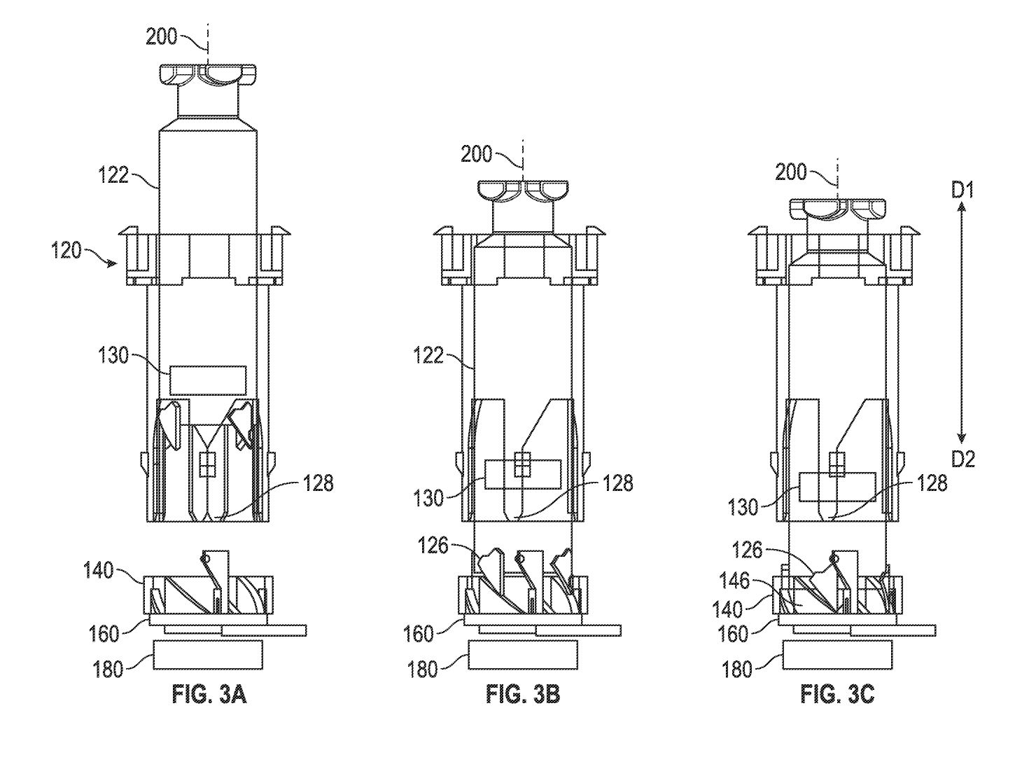

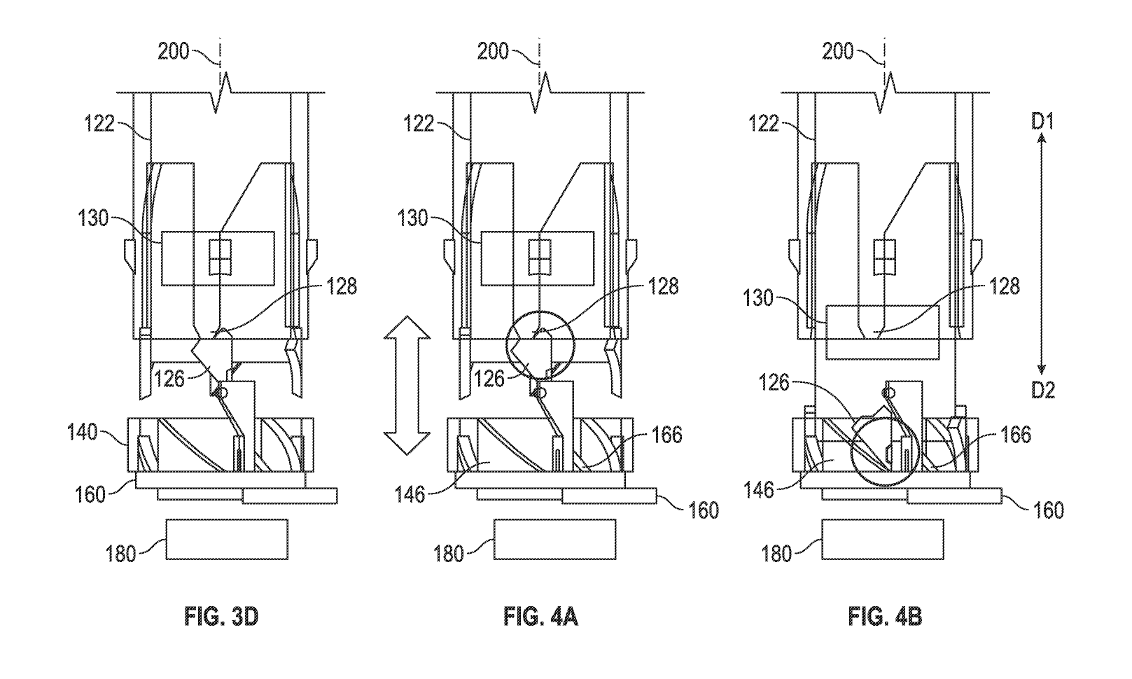

With reference now to FIGS. 3 A-D, an illustration of the movement of the latching mechanism 120 from the open position to the closed position is provided. The biasing mechanism 190 is not shown in these Figures to provide a clearer view of the movement of the latching mechanism 120. As detailed above, one skilled in the art will appreciate that the biasing mechanism 190 axially bias the latching mechanism 120 towards the open position. In FIG. 3A, the latching mechanism 120 is in the open position and the unlocked position. The plunger 122 is fully extended in a vehicle outward direction.

In FIG. 3B the plunger 122 is partially depressed in a vehicle inward direction D2 by the fuel door 24 (not shown). When the plunger 122 is depressed far enough in a vehicle inward direction D2, the latching teeth 126 of the plunger 122 come into contact with the locking teeth 146 of the locking mechanism 140. As the plunger 122 is further depressed in the vehicle inward direction D2, the interaction between the angles of the latching teeth 126 and the locking teeth 146 causes the plunger 122 to rotate about the axis 200 towards the locked position.

In FIG. 3C, the plunger 122 is fully depressed in the vehicle inward direction D2. The plunger 122 has fully rotated about the axis 200 and is in the locked position. The plunger 122 has passed through the closed position and, in an embodiment, the plunger 122 contacts a stop and cannot be depressed further in the vehicle inward direction D2.

In FIG. 3D, the plunger 122 is released and moves in the vehicle outward direction D1 into the closed position. In the closed position, the fuel door 24 is flush with the exterior surface of the vehicle. The plunger 122 may be biased towards the open position in the vehicle outward direction D1 by the biasing mechanism 190. In the closed position, the latching teeth 126 engage a plurality of latch stops 128 on the plunger housing 124. In this way, the plunger 122 is held in the closed position by the vehicle outward force of the biasing mechanism 190 pressing the latching teeth 126 against the latch stops 128.

FIGS. 4 A-B show in greater detail the position of the unlocking mechanism 160 when the plunger 122 is in the locked position. As shown in FIG. 4A, the unlocking mechanism 160 is rotated about the axis 200 such that the unlocking teeth 166 are not directly below the latching teeth 126. In this way, when the plunger 122 is further depressed in the vehicle inward direction D2 from the closed position as shown in FIG. 4B, the latching teeth 126 do not contact the unlocking teeth 166, the latching mechanism 120 does not rotate about the axis 200 to the unlocked position, and the fuel door 24 remains both closed and locked.

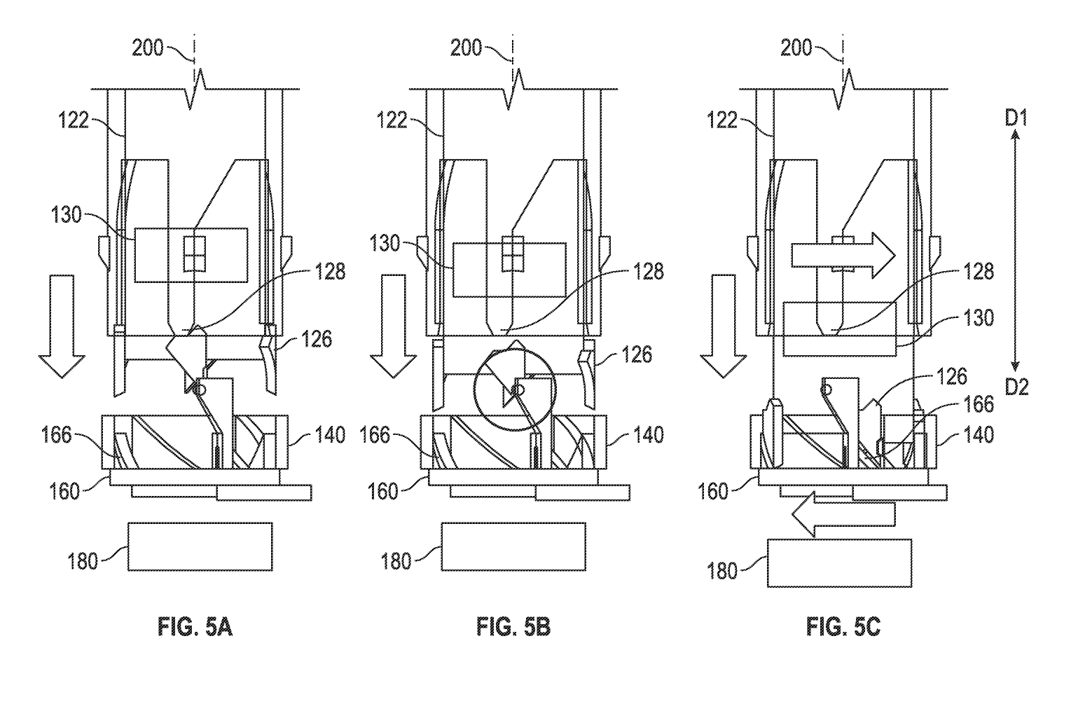

With reference now to FIGS. 5 A-C, an illustration of the movement of the latching mechanism 120 from the locked position to the unlocked position is provided. In FIG. 5A the latching mechanism 120 is in the closed position and the locked position. As discussed with reference to FIGS. 4 A-B, in this arrangement the latching mechanism 120 is unable to rotate into the unlocked position. When the unlocking mechanism 160 is unlocked, the actuator 170 rotates the unlocking mechanism 160 about the axis 200 so that the unlocking teeth 166 are directly underneath the latching teeth 126, as shown in FIG. 5C. When the plunger 122 is further depressed in the vehicle inward direction D2 from the closed position, the latching teeth 126 come into contact with the unlocking teeth 166 of the unlocking mechanism 160.

As the plunger 122 is further depressed in the vehicle inward direction D2, the interaction between the angles of the latching teeth 126 and the unlocking teeth 166 causes the plunger 122 to rotate about the axis 200 towards the unlocked position. When the plunger 122 is biased towards the open position in the vehicle outward direction D1 by the biasing mechanism 190 in the unlocked position, the latching teeth 126 do not engage the latch stops 128 on the plunger housing 124. Accordingly, the latching mechanism 120 moves longitudinally along the axis 200 in the vehicle outward direction D1 to the open position.

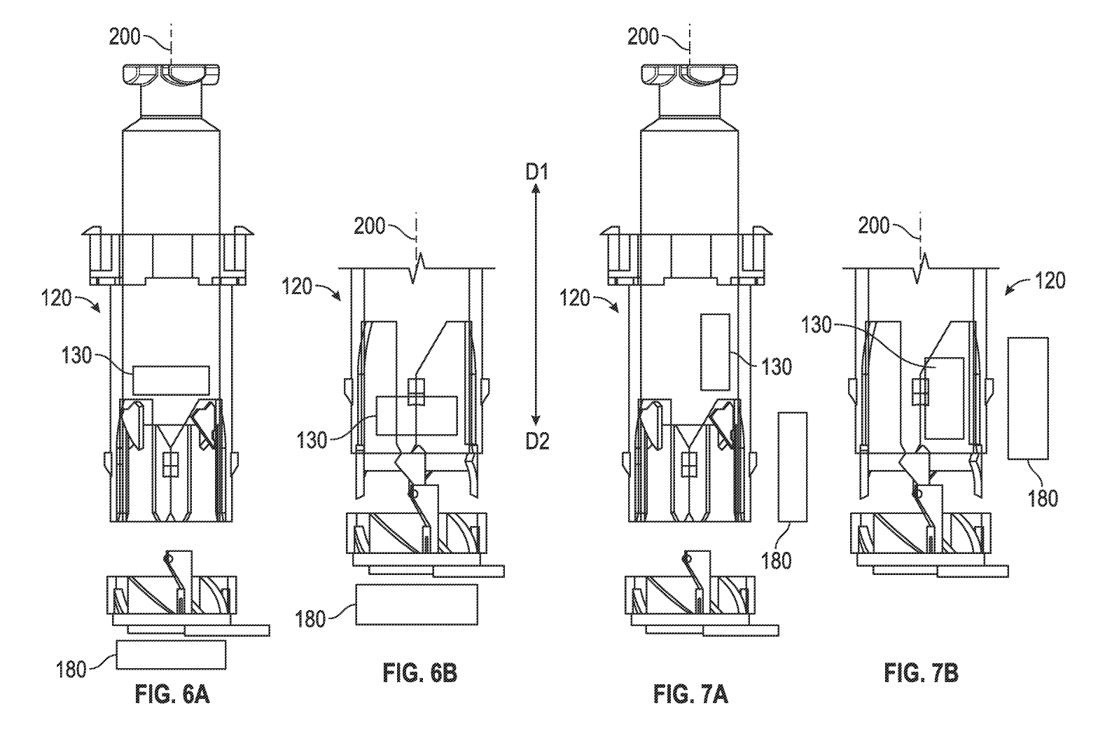

With continuing reference to FIGS. 1-5, the operation of the sensor module 180 will be described in relation to the sensing target 130 and the state of the latching mechanism 120 and the status of the fuel door 24. FIGS. 6 A-B illustrate a non-limiting arrangement of the sensing target 130 in the latching mechanism 120 and the sensor module 180. In this arrangement, the sensing target 130 and the sensor module 180 are generally co-axially aligned on the axis 200. In a non-limiting example the sensing target 130 is a magnet and the sensor module 180 is a Hall-Effect Sensor. As detailed above, a Hall-Effect sensor measures changes in magnetic fields.

FIG. 6A depicts the latching mechanism 120 in the open position and FIG. 6B depicts the latching mechanism 120 in the closed position. Since the sensor module 180 can measure a position of the sensing target 130, the sensor module 180 can be used to determine when the latching mechanism 120 is in the open position and the closed position. As discussed above, the position of the latching mechanism 120 corresponds to the status of the fuel door 24. When the latching mechanism 120 is in the open position, the fuel door 24 is open. Similarly, when the latching mechanism 120 is in the closed position, the fuel door 24 is closed.

The sensor module 180 can also measure an orientation of the sensing target 130. The latching mechanism 120 rotates from the unlocked position to the locked position, and vice versa. As such, the orientation of the sensing target 130 about the axis 200 with respect to the sensor module 180 can be used to determine when the latching mechanism 120 is in the locked position and the unlocked position. As discussed above, the position of the latching mechanism 120 corresponds to the status of the fuel door 24. When the latching mechanism 120 is in the unlocked position, the fuel door 24 is unlocked. Similarly, when the latching mechanism 120 is in the locked position, the fuel door 24 is locked.

With reference now to FIGS. 7 A-B, a non-limiting arrangement of the sensing target 130 in the latching mechanism 120 and the sensor module 180 is provided. In this arrangement, and in contrast to the embodiment of FIGS. 6 A-B, sensor module 180 is located generally radially outward from the axis 200. In this arrangement, the sensing target 130 passes by the sensor module 180 when the latching mechanism 120 is in the closed position. In a non-limiting example the sensing target 130 is a magnet and the sensor module 180 is a Hall-Effect Sensor. As detailed above, a Hall-Effect sensor measures changes in magnetic fields.

A FIG. 7A depicts the latching mechanism 120 in the open position and FIG. 7B depicts the latching mechanism 120 in the closed position. Since the sensor module 180 can measure a position of the sensing target 130, the sensor module 180 can be used to determine when the latching mechanism 120 is in the open position and the closed position. As discussed above, the position of the latching mechanism 120 corresponds to the status of the fuel door 24. When the latching mechanism 120 is in the open position, the fuel door 24 is open. Similarly, when the latching mechanism 120 is in the closed position, the fuel door 24 is closed.

The sensor module 180 can also measure an orientation of the sensing target 130. The latching mechanism 120 rotates from the unlocked position to the locked position, and vice versa. As such, the orientation of the sensing target 130 about the axis 200 with respect to the sensor module 180 can be used to determine when the latching mechanism 120 is in the locked position and the unlocked position. As discussed above, the position of the latching mechanism 120 corresponds to the status of the fuel door 24. When the latching mechanism 120 is in the unlocked position, the fuel door 24 is unlocked. Similarly, when the latching mechanism 120 is in the locked position, the fuel door 24 is locked.

In all of the previously described embodiments, the sensor module 180 can be replaced with an inductive position sensor. In this way, it is contemplated that different position and orientation sensors may be used in the sensor module 180 without departing from the spirit of the invention.

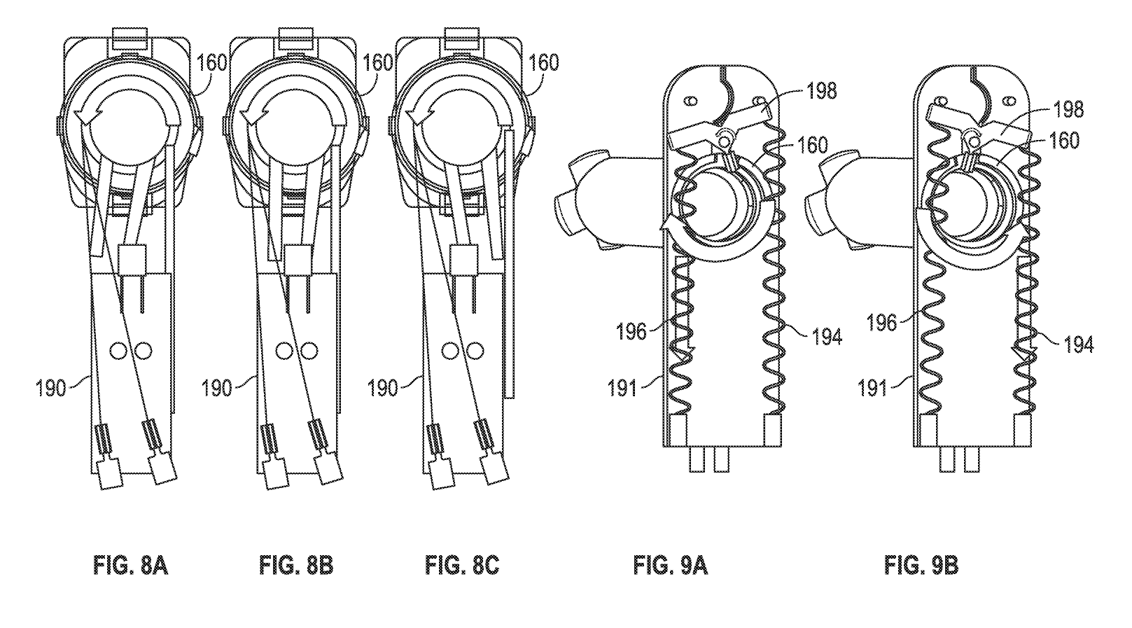

With reference now to FIGS. 8 A-C, a non-limiting embodiment of the unlocking mechanism 160 and the actuator 190 is illustrated. When the actuator 190 receives a signal to unlock the unlocking mechanism 160, the actuator 190 rotates the unlocking mechanism 160 about the axis 200 as detailed above. In the non-limiting embodiment of FIGS. 8 A-C, the actuator 190 is a magnetic actuator biased to hold the unlocking mechanism 160 in the locked position. In this way, the latching mechanism 120 is by default held in the locked position. When the actuator 190 receives a signal from a vehicle system (not shown) to unlock the fuel door 24, the actuator rotates the unlocking mechanism 160 about the axis 200.

With reference now to FIGS. 9 A-B, a non-limiting embodiment of the unlocking mechanism 160 and the actuator 190 is illustrated. When the actuator 190 receives a signal to unlock the unlocking mechanism 160, the actuator rotates the unlocking mechanism 160 about the axis 200 as detailed above. In the non-limiting embodiment of FIGS. 9 A-B, the actuator 190 is a mechanical actuator biased to hold the unlocking mechanism 160 in the locked position. In this way, the latching mechanism 120 is by default held in the locked position. When the actuator 190 receives a signal from a vehicle system (not shown) to unlock the fuel door 24, the actuator rotates the unlocking mechanism 160 about the axis 200.

While various exemplary embodiments have been presented in the foregoing detailed description, it should be appreciated that a vast number of variations exist. It should also be appreciated that the exemplary embodiments are only examples, and are not intended to limit the scope, applicability, or configuration of the disclosure in any way. Rather, the foregoing detailed description will provide those skilled in the art with a convenient road map for implementing the exemplary embodiments. It should be understood that various changes can be made in the function and arrangement of elements without departing from the scope of the disclosure as set forth in the appended claims and the legal equivalents thereof.

What is claimed is:

1. A system, for determining a status of a fuel door, comprising:
a latching mechanism having a sensing target and an axis, the latching mechanism rotatable about the axis through an unlocked position and a locked position and longitudinally movable about the axis between an open position and a closed position; and
a sensor module configured to detect a sensed position of the sensing target,
wherein the sensed position of the sensing target determines a state of the latching mechanism and the status of the fuel door.

2. The system of claim 1, wherein the sensor module is selected from a group comprising a hall effect sensor and an inductive position sensor.

3. The system of claim 1, further comprising:
a locking mechanism configured to rotate the latching mechanism from the unlocked position to the locked position in response to the latching mechanism moving from the open position to the closed position; and
an unlocking mechanism configured to selectably permit the latching mechanism to rotate from the locked position to the unlocked position.

4. The system of claim 1, wherein the state of the latching mechanism is selected from the group comprising an open state, a closed state, a locked state, and an unlocked state.

5. The system of claim 1, further comprising:
a biasing mechanism configured to bias the latching mechanism in the open position.

6. The system of claim 1, wherein the sensor module is located along the axis of the latching mechanism.

7. The system of claim 1, wherein the sensor module is located radially outward from the axis of the latching mechanism.

8. The system of claim 1, wherein the unlocking mechanism is electronically actuated.

9. A system for determining a status of a fuel door, comprising:
a latching mechanism having a sensing target and an axis, the latching mechanism rotatable about the axis through an unlocked position and a locked position and longitudinally movable about the axis between an axially outermost open position, an axially inward latched position, and an axially innermost depressed position; and
a sensor module configured to detect a sensed position of the sensing target, the sensed position of the sensing target determines a state of the latching mechanism and the status of the fuel door.

10. The system of claim 9, wherein the sensor module is selected from the group comprising a hall effect sensor and an inductive position sensor.

11. The system of claim 9, further comprising:
a plurality of angled latching teeth about a lower circumference of the latching mechanism;
a biasing mechanism configured to axially bias the latching mechanism towards the open position;
a locking mechanism having a plurality of angled locking teeth, the angled locking teeth configured to engage the angled latching teeth and rotate the latching mechanism from the unlocked position to the locked position in response to the latching mechanism moving axially inward from the open position to the depressed position;
a latch stop configured to hold the latching mechanism in the latched position when the latching mechanism is in the locked position; and
an unlocking mechanism configured to selectably permit the latching mechanism to rotate from the locked position to the unlocked position in response to the latching mechanism moving axially inward from the latched position to the depressed position.

12. The system of claim 9, wherein the state of the latching mechanism is selected from the group comprising an open state, a closed state, a locked state, and an unlocked state.

13. The system of claim 9, wherein the sensor module is located along the axis of the latching mechanism.

14. The system of claim 9, wherein the sensor module is located radially outward from the axis of the latching mechanism.

15. The system of claim 12, wherein the unlocking mechanism is electronically actuated.

16. A fuel port assembly for a vehicle, comprising:
a fuel port housing mounted to the vehicle;
a fuel door movably mounted with a hinge to the housing; and
a system for determining a status of the fuel door, the system mounted to the housing and comprising:
a latching mechanism having a sensing target and an axis, the latching mechanism rotatable about the axis through an unlocked position and a locked position and longitudinally movable about the axis between an axially outermost open position, an axially inward latched position, and an axially innermost depressed position; and
a sensor module configured to detect a sensed position of the sensing target, the sensed position of the sensing target determines a state of the latching mechanism and the status of the fuel door.

17. The fuel port assembly of claim 16, wherein the sensor module is selected from a group comprising a hall effect sensor and an inductive position sensor.

18. The fuel port assembly of claim 16, further comprising:
a plurality of angled latching teeth about a lower circumference of the latching mechanism;
a biasing mechanism configured to axially bias the latching mechanism towards the open position;
a locking mechanism having a plurality of angled locking teeth, the angled locking teeth configured to engage the angled latching teeth and rotate the latching mechanism from the unlocked position to the locked position in response to the latching mechanism moving axially inward from the open position to the depressed position;
a latch stop configured to hold the latching mechanism in the latched position when the latching mechanism is in the locked position; and
an unlocking mechanism configured to selectably permit the latching mechanism to rotate from the locked position to the unlocked position in response to the latching mechanism moving axially inward from the latched position to the depressed position.

19. The fuel port assembly of claim 16, wherein the state of the latching mechanism is selected from the group comprising an open state, a closed state, a locked state, and an unlocked state.

20. The fuel port assembly of claim 16, wherein the sensor module is located along the axis of the latching mechanism and/or radially outward from the axis of the latching mechanism.
